(19) United States
(12) Patent Application Publication
(10) Pub. No.: US 2013/0143015 A1
(43) Pub. Date: Jun. 6, 2013

(54) TOUGH MULTI-MICROLAYER FILMS

(71) Applicants: Shawn E. Jenkins, Duluth, GA (US); Renee L. Johns, Alpharetta, GA (US)

(72) Inventors: Shawn E. Jenkins, Duluth, GA (US); Renee L. Johns, Alpharetta, GA (US)

(21) Appl. No.: 13/311,236

(22) Filed: Dec. 5, 2011

(51) Int. Cl. B32B 27/08; C08L 23/10; B32B 27/12; B32B 5/02; B32B 7/02

(52) U.S. Cl. 428/216; 428/516; 442/398; 442/394; 525/240

(57) ABSTRACT

Disclosed are multi-microlayer films having alternating first and second layers, the first layers including an ethylene-based copolymer composition and the second layers comprising a propylene-based copolymer composition, wherein each layer optionally comprises from about 0 to about 20% by weight of a polyolefin polymer. The multi-microlayer films have desirable tensile properties and are useful as components in absorbent personal care products.

### BACKGROUND OF THE INVENTION

Film materials are commonly incorporated into various products as a barrier. For example, in absorbent care products (e.g., diapers, training pants, garments, etc.) a film may be used for the purpose of preventing leakage of body fluids. To control raw material costs, it is desirable to minimize the thickness of films. However, it is easy to see that reducing the thickness of films inherently reduces their tensile and tear properties. Accordingly, there is an ever-present need to reduce the thickness of film materials without sacrificing tensile and tear properties. It is to this need that the present invention is directed.

### SUMMARY OF THE INVENTION

The present invention is directed to a multi-microlayer film having alternating first and second microlayers. The first microlayers include an ethylene-based copolymer composition and the second microlayers include a propylene-based copolymer composition. Each microlayer optionally includes from about 0% to about 20% by weight polyolefin polymer, or suitably from about 5 to about 20% by weight polyolefin polymer. The polyolefin polymer may be a polyolefin homopolymer or copolymer of an olefin with another alpha-olefin. In one embodiment, the polyolefin polymer may be selected from the group consisting of polypropylene, polyethylene, and polybutylene. In another embodiment, the polyolefin polymer may be polyethylene, optionally low density polyethylene.

In one aspect, the multi-microlayer film may have at least four microlayers.

In another aspect, the first and second microlayers may be sandwiched between two skin layers having composition different from the first and second microlayers.

In a further aspect, the first and second microlayers may each thickness of about 6 microns. In an even further aspect, the first and second microlayers may each have a minimum thickness of about 40 nanometers.

In one aspect, each first and second microlayer may include polyethylene in a range selected from the group consisting of from about 0.5 to about 20% by weight, from about 5 to about 15% by weight, and from about 8 to about 12% by weight. The polyethylene may be linear low density polyethylene.

In one aspect, the ratio of ethylene-based copolymer to propylene-based copolymer may be in a range from about 2:1 to about 4:1.

In one embodiment, a film includes from about 25 wt. % to about 46 wt. % by weight ethylene-based copolymer, from about 25 wt. % to about 46 wt. % by weight propylene-based copolymer, and from about 0.5% to about 20% by weight polyolefin polymer.

In one aspect, the ratio of ethylene-based copolymer to propylene-based copolymer may be in a range from about 2:1 to about 4:1.

The films described herein may be a component of a laminate that also includes a nonwoven material. In one aspect, the films or film laminates may be a component of an absorbent article that includes an outer cover, a bodyside liner joined to the outer cover, and an absorbent core positioned between the outer cover and the bodyside liner.

### BRIEF DESCRIPTION OF THE DRAWINGS

FIG. 1 is a plan view of a coextrusion system for making a microlayer polymer film in accordance with an embodiment of this invention.

FIG. 2 is a schematic diagram illustrating a multiplying die element and the multiplying process used in the coextrusion system illustrated in FIG. 1.

FIG. 3 is scanning electron microscopy (SEM) micrographs showing a representative cross-sectional view of multi-microlayer film.

FIG. 4 is a graph depicting tensile properties of various example films.

FIG. 5 is a graph depicting tensile properties of various example films.

FIG. 6 is a graph depicting tensile properties of various example films.

### DETAILED DESCRIPTION OF THE INVENTION

The present invention encompasses a multi-microlayer film having alternating first and second layers, the first layers comprising an ethylene-based copolymer composition and the second layers comprising a propylene-based copolymer composition, wherein each layer optionally comprises from about 0 to about 20% by weight of a polyolefin polymer. Below is a detailed description of embodiments of this invention including a method for coextruding the microlayer polymer film, followed by a description of uses and properties of the film and particular examples of the film.

This invention includes multi-microlayer films composed of a multi-microlayer assembly of alternating layers of a first composition and a second composition. The first composition comprises an ethylene-based copolymer. The second composition includes a propylene-based copolymer. Either the first composition, the second composition, or both the first and second compositions may further comprise a polyolefin polymer. As used herein, “multi-microlayer” means a film having a plurality of alternating layers wherein, based upon the process by which the film is made, each microlayer becomes partially integrated or adhered with the layers above and below the microlayer. This is in contrast to “multi-layer” films wherein conventional co-extruded film-making equipment forms a film having only a few layers and wherein each layer is generally separate and distinct from each other layer. Microlayers, however, form laminate films with high integrity and strength because they do not substantially delaminate after microlayer coextrusion due to the partial integration or strong adhesion of the microlayers. Microlayers enable combinations of two or more layers into a monolithic film with a strong coupling between individual layers. The term “monolithic film” as used herein means a film that has multiple layers which adhere to one another and function as a single unit.

The multi-microlayer films are designed to have enhanced tensile and tear characteristics. As one example, the multi-microlayer films may be used as a film component in personal and health care products.

The multi-microlayer film of this invention comprises a plurality of coextruded microlayers which form a laminate structure. The coextruded microlayers include a plurality of first layers and a plurality of second layers. The plurality of first layers and plurality of the second polymer layers are arranged in a series of parallel repeating laminate units. Each laminate unit comprises at least one of the first layers and at least one of the second layers. In some embodiments, each laminate unit has one second layer laminated to a first layer so that the coextruded microlayers alternate between first layers and second layers, i.e., an NB arrangement. Alternatively, the laminate unit may have three or more layers, for example, an A/B/A arrangement.

In the case of the A/B laminate unit, the resulting multi-microlayered film is arranged as A/B/A/B . . . A/B, where one side is always “A” and the other side is always “B”. However, as another option, an initial three-layer melt configuration (i.e., A/B/A) may be used. In the case of the A/B/A arrangement, the resulting multi-microlayered film is arranged as A/B/A/A/B/A/AB/A . . . A/B/A. In this case, both sides of the multi-microlayered film are always A. In addition, there are adjacent NA layers imbedded in the multi-microlayered film. As a matter of convention in the examples presented, adjacent layers of the same composition are counted as two distinct layers. For instance, an A/A arrangement is counted as two distinct layers, even though their individual delineation cannot be visualized directly. In addition, in the examples presented below, the number of “splitters” used in making the film, i.e., the number of times layers are doubled starting from a three-layer A/B/A melt, is presented along with the theoretical number of layers in the extruded film.

Each microlayer in the polymer film has a thickness from about 0.05 microns to about 150 microns, or suitably from about 0.05 to about 50 microns, or more suitably from about 0.05 microns to about 5 microns. In one embodiment, each microlayer has a thickness that does not exceed about 100 microns, or suitably about 50 microns, or more suitably about 1 micron. In another embodiment, each microlayer may have a thickness that is not less than about 0.50 microns, or more suitably not less than about 0.2 microns, or more suitably not less than about 0.04 microns. In still another embodiment, each microlayer has a thickness that is not less than about 0.15 micron. In still another embodiment, the microlayers of the film may have a thickness from about 0.1 microns to about 90 microns.

The number of microlayers in the film of this invention varies broadly from about 3 to about 4000, suitably from about 5 to about 1000, and more suitably from about 8 to about 200 in number. However, based upon the thickness of each microlayer, the number of microlayers in the film is determined by the desired overall film thickness. In one embodiment, the multi-microlayer films have a thickness of from about 5 to about 500 microns, suitably from about 10 to about 100 microns. In another embodiment, the films have a thickness of from about 1 to about 10 microns. Basis weight of the films may range in some embodiments from about 10 gsm (grams per square meter) to about 100 gsm, in other embodiments from about 20 gsm to about 80 gsm.

The first and second compositions that comprise the first and second layers of the multi-microlayer film generally comprise at least one melt-extrudable polymer. The term “melt-extrudable polymer” as used herein means a thermoplastic material having a melt flow rate (MFR) value of not less than about 0.1 grams/10 minutes, based on ASTM D1238. More particularly, the MFR value of suitable melt-extrudable polymers ranges from about 0.1 g/10 minutes to about 100 g/10 minutes. In another embodiment, the MFR value of suitable melt-extrudable polymers ranges from about 0.2 g/10 minutes to about 50 g/10 minutes. In yet another embodiment the MFR value ranges from about 0.4 g/10 minutes to about 50 g/10 minutes to provide desired levels of processability.

For example, the first composition may include a melt-extrudable polymer that comprises an ethylene-based copolymer. As another example, the second composition may include a melt-extrudable polymer that comprises a propylene-based copolymer.

Still more particularly, suitable melt-extrudable polymers for use in this invention may be stretchable and elastic in solid state to allow stretching and recovery of the multi-microlayered film. Stretching in the solid state is defined as stretching at a temperature below the melting point of the melt-extrudable polymer.

As described above, the first layers of the multi-microlayer film comprise a first composition that comprises an ethylene-based copolymer. There exists a wide variety of ethylene-based copolymers suitable for use with the present invention. The first composition may comprise any ethylene-based copolymer suitable for film formation. Film-forming ethylene-based copolymers suitable for use with the present invention, alone or in combination with other polymers, include, by way of example only, elastic ethylene-based copolymers made by “metallocene”, “constrained geometry” or “single-site” catalysts. Suitable ethylene-based copolymer elastomers include polyethylene copolymers having density less than about 0.89 grams/cc. Examples of such catalysts and polymers are described in U.S. Pat. No. 5,472,775 to Obijeski et al.; U.S. Pat. No. 5,451,450 to Erderly et al.; U.S. Pat. No. 5,278,272 to Lai et al.; U.S. Pat. No. 5,272,236 to Lai et al.; U.S. Pat. No. 5,204,429 to Kaminsky et al.; U.S. Pat. No. 5,539,124 to Etherton et al.; and U.S. Pat. No. 5,554,775 to Krishnamurti et al.; the entire contents of which are incorporated herein by reference. The aforesaid patents to Obijeski and Lai teach exemplary polyethylene-based copolymer elastomers and, in addition, exemplary low density polyethylene elastomers are commercially available from The Dow Chemical Company under the trade name AFFINITY, from ExxonMobil Chemical Company, under the trade name EXACT, and from Dupont Dow Elastomers, L.L.C. under the trade name ENGAGE.

The first composition may comprise from about 50 wt. % to about 98 wt. % of the ethylene-based copolymer, more desirably from about 60 wt. % to about 95 wt. %, and even more desirably from about 70 to about 90 wt. % by weight of the first composition.

Some further described above, the second layers of the multi-microlayer film comprise a second composition that comprises a propylene-based copolymer. There exists a wide propyplene-based copolymers suitable for use with the present invention. The second composition may comprise any propylene-based copolymer suitable for film formation. Film-forming propylene-based copolymers suitable for use with the present invention, alone or in combination with other polymers, include, by way of example only, elastic propylene-based copolymers made by “metallocene”, “constrained geometry” or “single-site” catalysts. Suitable propylene-based copolymer elastomers include polypropylene copolymers having density less than about 0.89 grams/cc. Examples of such catalysts and polymers are described in U.S. Pat. No. 5,472,775 to Obijeski et al.; U.S. Pat. No. 5,451,450 to Erderly et al.; U.S. Pat. No. 5,278,272 to Lai et al.; U.S. Pat. No. 5,272,236 to Lai et al.; U.S. Pat. No. 5,204,429 to Kaminsky et al.; U.S. Pat. No. 5,539,124 to Etherton et al.; and U.S. Pat. No. 5,554,775 to Krishnamurti et al.; the entire contents of which are incorporated herein by reference. The aforesaid patents to Obijeski and Lai teach exemplary polypropylene-based copolymer elastomers and, in addition, exemplary propylene-ethylene copolymer plastomers and elastomers are commercially available from The Dow Chemical Company under the trade name VERSIFY and ExxonMobil Chemical Company under the trade name VISTAMAXX.

The second composition may comprise from about 50 wt. % to about 98 wt. % of the propylene-based copolymer, more desirably from about 60 wt. % to about 96 wt. %, and even more suitable from about 70 to about 94 wt. % by weight of the second composition.

The first and second compositions may further include a polyolefin polymer. The polyolefin polymer may be a polyolefin homopolymer or copolymer of an olefin with another alpha-olefin. Exemplary polyolefin polymers include polyethylene, polypropylene, polybutylene, and so forth. One desirable polyolefin polymer is low density polyethylene, an example of which is LDPE 6211 polyethylene available from The Dow Chemical Company. The polyolefin polymer may be present in either or both of the first and second compositions in an amount ranging from about 1 wt. % to about 25 wt. %, more desirably from about 2 wt. % to about 20 wt. %, and even more desirably from about 5 wt. % to about 20 wt. %, or from about 5 wt. % to about 15 wt. % of the first or second composition as the case may be. In one desirable embodiment, the polyolefin polymer may comprise about 10 wt. % of either one or both of the first and second compositions by weight of the first and/or second compositions respectively.

The first composition may be present in the multi-microlayer film in an amount ranging from about 25 to about 90 wt. %, more suitably from about 50 to about 85 wt. %, and even more suitably in an amount from about 60 to about 80 wt. %.

The second composition may be present in the multi-micro-layer film in an amount ranging from about 10 to about 75 wt. %, more suitably from about 15 to about 50 wt. %, and even more suitably in an amount from about 20 to about 40 wt. %.

Other additives may also be incorporated into the first and second compositions, such as melt stabilizers, crosslinking catalysts, pro-rad additives, processing stabilizers, heat stabilizers, light stabilizers, antioxidants, heat aging stabilizers, whitening agents, antiblocking agents, bonding agents, tackifiers, viscosity modifiers, etc. Examples of suitable tackifier resins may include, for instance, hydrogenated hydrocarbon resins. REGALREZ™ hydrocarbon resins are examples of such hydrogenated hydrocarbon resins, and are available from Eastman Chemical. Other tackifiers are available from ExxonMobil under the ESCOREZ™ designation. Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of microlayer films. Some suitable hindered phenols include those available from Ciba Specialty Chemicals of under the trade name “Irganox®”, such as Irganox® 1076, 1010, or E 201. Moreover, bonding agents may also be added to the film to facilitate bonding of the film to additional materials (e.g., nonwoven web). Typically, such additives (e.g., tackifier, antioxidant, stabilizer, etc.) are each present in an amount from about 0.001 wt. % to about 25 wt. %, in some embodiments, from about 0.005 wt. % to about 20 wt. %, and in some embodiments, from 0.01 wt. % to about 15 wt. % of the first and/or second compositions.

The multi-microlayer film may further include other functional layers. As one example, the multi-microlayer film may further include other elastic layers or thermoplastic layers that may or may not be microlayered. Films that include elastic layers and thermoplastic layers for which the multi-microlayer film of the present invention may be utilized as one of the elastic layers or thermoplastic layers are described, for example, in U.S. Patent Publication 2009/0325447, which is incorporated herein in its entirety by reference thereto for all purposes. The other functional layers may comprise from about 20% wt. % to about 1000% wt. % of the basis weight of the multi-microlayers, suitably from about 35 wt. % to about 800 wt. % of the basis weight of the multi-microlayers, or more suitably from about 50 wt. % to about 600 wt. % of the basis weight of the multi-microlayers.

The multi-microlayer film may further include one or two additional skin layer(s) on the outer surfaces of the multi-microlayer film. The skin layer(s) may impart electrostatic dissipation, stabilize the film during extrusion, or provide other benefits to the overall structure. The skin layer(s) may generally be formed from any film-forming polymer. If desired, the skin layer(s) may contain a softer, lower melting polymer or polymer blend that renders the skin layer(s) more suitable as heat seal bonding layers for thermally bonding the film to a nonwoven web. In most embodiments, the skin layer(s) are formed from a film-forming, thermoplastic, melt extrudable polymers such as are known in the art. Suitably, the skin layers may further include one or more of the additives described above. Typically, such additives (e.g., tackifier, antioxidant, stabilizer, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the skin layer.

The microlayer films may be post-processed to stabilize the film structure. The post processing may be done by a thermal point or pattern bonding, by embossing, by sealing edges of the film using heat or ultrasonic energy, or by other operations known in the art. One or more nonwoven webs may be laminated to the film with microlayers to improve strength of the film, its tactile properties, appearance, or other beneficial properties of the film. The nonwoven webs may be spunbond webs, meltblown webs, bonded carded webs, airlaid or wet laid webs, or other nonwoven webs known in the art.

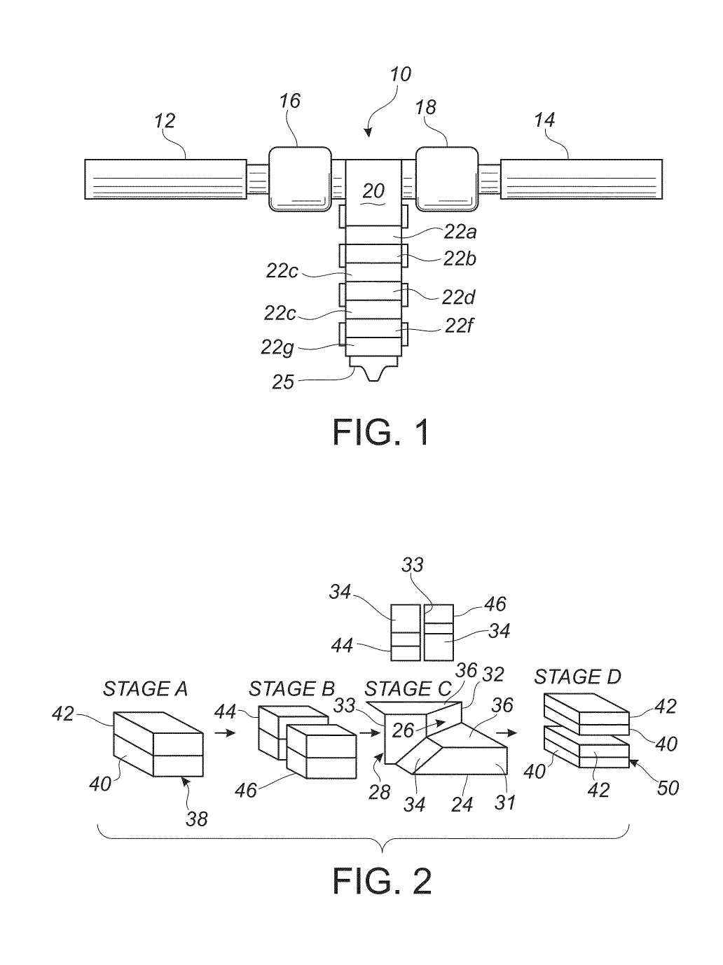

A suitable method for making the microlayer film of this invention is a microlayer coextrusion process wherein two or more polymers compositions are coextruded to form a laminate with two or more layers, which laminate is then manipulated to multiply the number of layers in the film. FIG. 1 illustrates a coextrusion device 10 for forming microlayer films. This device includes a pair of opposed single-screw extruders 12 and 14 connected through respective metering pumps 16 and 18 to a coextrusion block 20. A plurality of multiplying elements, referred to in the examples as “splitters”, 22a-g extends in series from the coextrusion block perpendicularly to the single-screw extruders 12 and 14. Each of the multiplying elements includes a die element 24 disposed in the melt flow passageway of the coextrusion device. The last multiplying element 22g is attached to a discharge nozzle 25, for example, a film die, through which the final product extrudes. While single-screw extruders are shown, the present invention may also use twin-screw extruders to form the films of the present invention.

A schematic diagram of the coextrusion process carried out by the coextrusion device 10 is illustrated in FIG. 2. FIG. 2 also illustrates the structure of the die element 24 disposed in each of the multiplying elements 22a-g. Each die element 24 divides the melt flow passage into two passages 26 and 28 with adjacent blocks 31 and 32 separated by a dividing wall 33. Each of the blocks 31 and 32 includes a ramp 34 and an expansion platform 36. The ramps 34 of the respective die element blocks 31 and 32 slope from opposite sides of the melt flow passage toward the center of the melt flow passage. The expansion platforms 36 extend from the ramps 34 on top of one another.

To make a microlayer film using the coextrusion device 10 illustrated in FIG. 1, a first polymer composition, is extruded through the first single screw extruder 12 into the coextrusion block 20. Likewise, a second polymer composition is extruded through the second single screw extruder 14 into the same coextrusion block 20. In the coextrusion block 20, a melt laminate structure 38 such as that illustrated at stage A in FIG. 2 is formed with the first polymer composition forming a layer on top of a layer of the second polymer composition.

The coextrusion block 20 can be configured to provide an “asymmetrical” side-by-side configuration of the polymers from the two extruders 12, 14 (i.e., A/B configuration) or a “symmetrical” skin/core/skin configuration (i.e., A/B/A). Other starting structures may be coextruded from the feedblock as will be appreciated by one skilled in the art. For example, in another embodiment, a third tie layer “C” (not shown) may be extruded by a third extruder (not shown) between “A” and “B” layers via an extrusion block configured to provide an A/C/B arrangement, or, alternatively, an A/C/B/C arrangement. Coextrusion blocks configured to provide an “asymmetric” flow such as A/B will likewise produce an “asymmetric” micro-multilayer film. That is, one outer (terminating) surface will always be composed of “A”, and the other terminating surface will always be predominantly composed of “B”. Similarly, extrusion blocks configured to provide a “symmetric” A/B/A flow element will produce a “symmetric” micro-multilayer film. That is, both terminating layers will be composed of “A”.

This can be utilized if polymer A or B has some preferential surface property, such as wettability, electrostatic discharge, surface tack, or some other attribute of importance to elastic film laminates.

The melt laminate is then extruded through the series of multiplying elements 22a-g to form a multi-layer microlaminate with the layers alternating between the first polymer composition and the second polymer composition. As the two-layer melt laminate is extruded through the first multiplying element 22a, the dividing wall 33 of the die element 24 splits the melt laminate 38 into two halves 44 and 46 each having a layer of the first polymer composition 40 and a layer of the second polymer composition 42. This is illustrated at stage B in FIG. 2. As the melt laminate 38 is split, each of the halves 44 and 46 are forced along the respective ramps 34 and out of the die element 24 along the respective expansion platforms 36. This reconfiguration of the melt laminate is illustrated at stage C in FIG. 2. When the melt laminate 38 exits from the die element 24, the expansion platform 36 positions the split halves 44 and 46 on top of one another to form a four-layer melt laminate 50 having, in parallel stacking arrangement, a first polymer composition layer, a second polymer composition layer, a first polymer composition layer, and a layer of the second polymer composition in laminate form. This process is repeated as the melt laminate proceeds through each of the multiplying elements 22b-g. When the melt laminate is discharged through the discharge nozzle 25, the melt laminate forms a film having from about 4 to about 1000 microlayers, depending on the number of multiplying elements.

The foregoing microlayer coextrusion device and process is described in more detail in an article Mueller et al., entitled Novel Structures By Microlayer Extrusion-Talc-Filled PP, PC/SAN, and HDPE-LLDPE, Polymer Engineering and Science, Vol. 37, No. 2, 1997. Similar processes are described in U.S. Pat. No. 3,576,707 and U.S. Pat. No. 3,051,453, the disclosures of which are expressly incorporated herein by reference. Other processes known in the art to form multi-microlayer film may also be employed, e.g., coextrusion processes described in W. J. Schrenk and T. Ashley, Jr., “Coextruded Multilayer Polymer Films and Sheets, Polymer Blends”, Vol. 2, Academic Press, New York (1978).

The relative thickness of the microlayers of the film made by the foregoing process may be controlled by varying the feed ratio of the polymers into the extruders, thus controlling the constituent volume fraction. In addition, one or more extruders may be added to the coextrusion device to increase the number of different compositions in the microlayer film. For example, a third extruder may be added to add a tie layer to the film.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

As mentioned above, the engineering tensile peak load (grams-force), stress (force at failure peak load divided by the cross-sectional are of the original specimen) (psi), and energy loading (g-cm/mm²) is tested in both machine direction orientation and cross direction orientation according to ASTM-D882-02. The “single sheet caliper” is measured as one sheet using an EMVECO 200-A Microgage automated micrometer (EMVECO, Inc., Oregon). The micrometer has an anvil diameter of 2.22 inches (56.4 millimeters) and an anvil pressure of 132 grams per square inch (per 6.45 square centimeters) (2.0 kPa). The MTS Sintech 1/S screw driven frame was used for the acquisition of the tensile data. The cross-head was displaced at a rate of 20 in./min. The data acquired was at a rate of 100 data points per cycle. The loading energy was calculated by integrating the area under the tensile curve.

Textest Tear is a measure of the average tearing force necessary to completely tear a test sample in one direction where the tear is initiated from a standard slit cut into the edge of the specimen being tested. The test is carried out in accordance with TAPPI method T-414 “Internal Tearing Resistance of Paper (Elmendorf-type method)” using, for example, a falling pendulum instrument (Lorentzen & Wettre Model SE 009).

More particularly, a rectangular test specimen to be tested is cut out of a sample such that the test specimen measures 63 mm (2.5 inches) in the direction to be tested (such as the MD or CD direction) and between 73 and 114 millimeters (2.9-4:6 inches) in the other direction. The specimen edges must be cut: parallel and perpendicular to the testing direction (not skewed). Any suitable cutting device, such as a paper cutter, can be used. The test specimen should be taken from areas of the sample that are free of folds, wrinkles, crimp lines, perforations or any other distortions that would make the test specimen abnormal from the rest of the material.

The test specimen is then placed between the clamps of the falling pendulum apparatus with the edge of the specimen aligned with the front edge of the clamp. The “Clamp” button is pressed to close the clamps. A 20-millimeter slit is cut into the leading edge of the specimen by pushing down on the cutting knife lever until it reaches its stop.

The slit must be clean with no tears or nicks. This slit will serve to start the tear during the subsequent test.

The pendulum is released by pushing down on the “Pend” button of the test instrument. The tear value, which is the force required to completely tear the test specimen, is displayed by the instrument and recorded. The test is repeated for a representative number of samples and the results are averaged. The average tear value: is the tear strength for the direction (MD or CD) tested.

The trapezoid or “trap” tear test is a tension test applicable to the nonwoven web. The entire width of the specimen is gripped between clamps, thus the test primarily measures the bonding or interlocking and strength of individual fibers directly in the tensile load, rather than the strength of the composite structure of the fabric as a whole. The test measures the fabric resistance to tear propagation under a constant rate of extension. A fabric cut on one edge is clamped along nonparallel sides of a trapezoidal shaped specimen and is pulled, causing a tear propagation in the specimen perpendicular to the load. The test can be conducted in either the MD or CD direction. In conducting the trap tear test, an outline of a trapezoid is drawn on a 3 by 6 inch (75 by 152 mm) specimen with the longer dimension in the direction being tested, and the specimen is cut in the shape of the trapezoid. The trapezoid has a 4 inch (102 mm) side and a 1 inch (25 mm) side which are parallel and which are separated by 3 inches (76 mm). A small preliminary cut of ⅝ inches (15 mm) is made in the middle of the shorter of the parallel sides. The specimen is clamped in, for example, an Instron Model™ (a constant-rate-of-extension tester), available from the Instron Corporation, 2500 Washington St., Canton, Mass., or a Thwing-Albert Model INTELLECT II available from the Thwing-Albert Instrument Co., 10960 Dutton Rd., Phila., Pa. 19154, which have 3 inch (76 mm) long parallel clamps. The specimen is clamped along the non-parallel sides of the trapezoid so that the fabric on the longer side is loose and the fabric along the shorter side taut, and with the cut halfway between the clamps.

A continuous load is applied on the specimen such that the tear propagates across the specimen width. It should be noted that the longer direction is the direction being tested even though the tear is perpendicular to the length of the specimen.

The force required to completely tear the specimen is recorded in pounds with higher numbers indicating a greater resistance to tearing. The test method used conforms to ASTM Standard test D 1117-14, except that the tearing load is calculated as the average of the first and highest peaks recorded rather than the lowest and highest peaks. Five specimens for each sample are typically tested.

The data presented include first and high peak values.

Basis weight is the mass per unit area of film and is generally expressed in units of grams per square meter.

Electron micrographs may be generated by conventional techniques that are well known in the imaging art. In addition, samples may be prepared by employing well known, conventional preparation techniques. For example, the imaging of the cross-section surfaces may be performed with a JEOL 6400 SEM.

Example films were extruded via a micro-layering film line.

Example Film 1 was a mono-layer film formed from a dry blend of 75% ethylene-based copolymer elastomer (Engage 8130 polyolefin elastomer available from The Dow Chemical Company) and 25% propylene-based elastomer (VMX 6102 propylene based elastomer available from Exxon-Mobil Chemical Company).

Example Film 2 was a three-layer film formed from 75% Engage 8130 polyolefin elastomer in the skin layers and 25% VMX 6102 propylene based elastomer in the core layer.

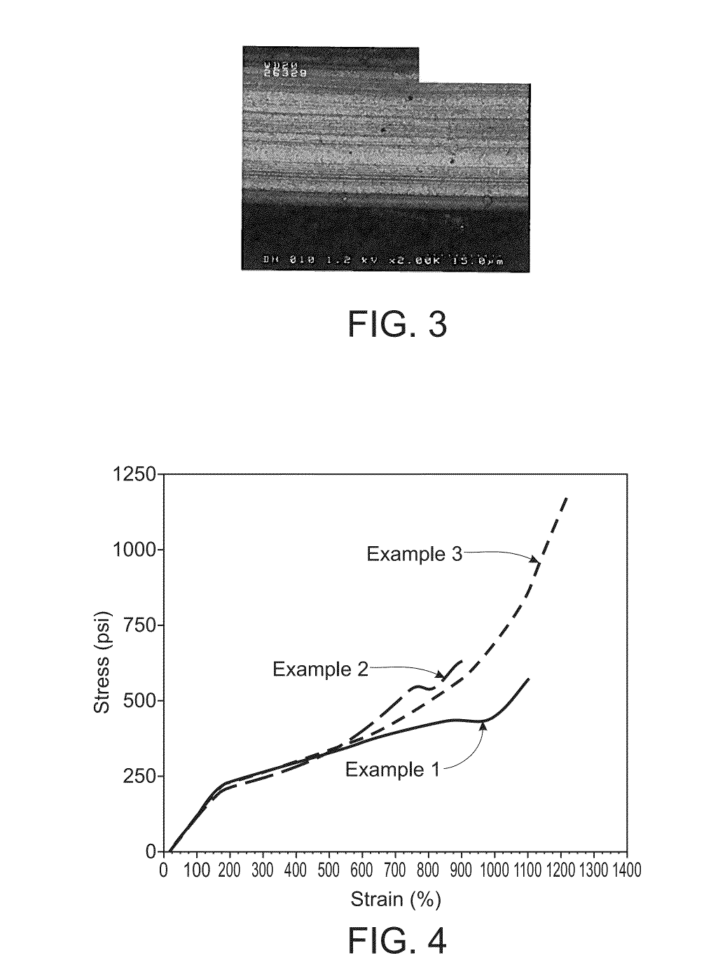

Example Film 3 was a 96-layer micro-layer film formed from 75% Engage 8130 polyolefin elastomer and 25% VMX 6102 propylene based elastomer in alternating layers. FIG. 3 depicts an SEM photograph of a cross-section of Example Film 3.

FIG. 4 depicts CD stress-strain curves for Example Films 1-3.

It is noted that Example Film 3 had 69% greater CD Tensile at Peak Load and 42% greater CD Energy to Break than Example Film 1. Example Film 2 had 12% lower CD Tensile at Peak Load and 43% lower CD Energy to Break than Example Film 1.

Example films 1a, 2a, and 3a corresponding in composition and structure to Examples films 1, 2, and 3 were produced to confirm results.

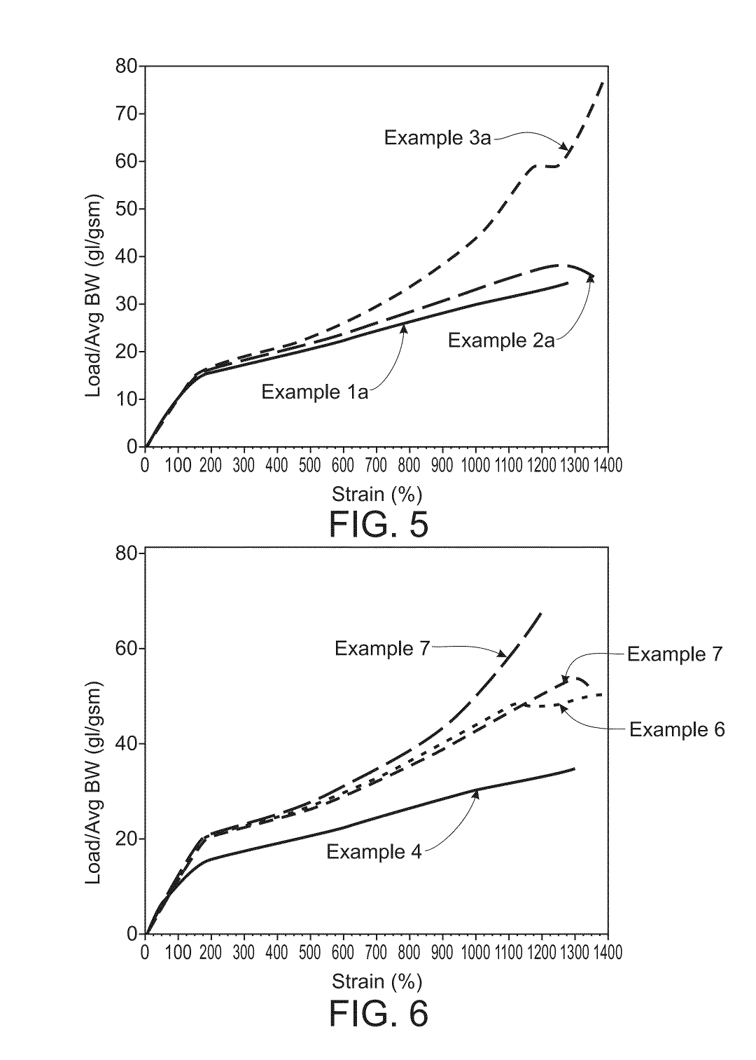

FIG. 5 depicts representative CD stress vs. strain curve for layered and dry blended films and illustrates the difference in stress/strain behavior layering provides, similar to the behavior noted in the first trial.

Relative to Example Film 1a, Example Film 3a showed 81% increase in CD Tensile at Peak Load, 13% increase in CD Energy to Break, 194% increase in CD Textest Tear and 35% increase in CD Trap Tear. Larger improvements were noted in the MD.

Relative to Example Film 1a, Example Film 2a showed 15% increase in CD Tensile at Peak Load, 20% increase in CD Energy to Break, 36% decrease in CD Textest Tear and 20% decrease in CD Trap Tear.

Example Film 4 was a mono-layer film formed from a dry blend of 75% Engage 8130 polyolefin elastomer and 25% VMX 6102 propylene based elastomer.

Example Film 5 was a mono-layer film formed from 10% polyethylene (Dow LDPE 6211 polyethylene available from The Dow Chemical Company) dry blended with 90 wt. % of a dry blend of 75% Engage 8130 polyolefin elastomer and 25% VMX 6102 propylene based elastomer.

Example Film 6 was a 96-layer micro-layer film of homogeneous composition formed from 10% polyethylene (Dow LDPE 6211 polyethylene available from The Dow Chemical Company) dry blended with 90 wt. % of a dry blend of 75% Engage 8130 polyolefin elastomer and 25% VMX 6102 propylene based elastomer.

Example Film 7 was a 96-layer micro-layer film formed from 75 wt. % of 10% polyethylene (Dow LDPE 6211 polyethylene available from The Dow Chemical Company) dry blended with 90 wt. % Engage 8130 polyolefin elastomer and 25 wt. % of 10% Dow LDPE 6211 polyethylene dry blended with 90 wt. % VMX 6102 propylene based elastomer, in alternating layers.

FIG. 6 depicts representative CD stress vs. strain curves for the layered and dry blended films (Example Films 4-7) and illustrates the difference in stress/strain behavior that adding small amounts of polyethylene provides.

Adding PE to the dry blend and extruding a monolayer film increased CD/MD Textest Tear, CD/MD Trap Tear, Tensile Peak Load and Energy to Break over the film without any polyethene. Further, “layering” the PE-containing dry blend via 5 splitters resulted in most properties remaining unchanged to the monolayer PE dry blended film, (except for MD Textest Tear which increased 139% over the film without any polyethylene.

Interestingly, layering the polyethylene-based elastomer with the polypropylene-based elastomer, where each layer has 10 wt % polyethylene dry blended in, resulted in the most substantial improvement in properties over the dry blend without any polyethylene. For example, layering in conjunction with adding 10 wt % polyethylene (Example Film 7) resulted in 75% increase in CD Tensile Peak Load, 24% increase in CD Energy to Break, 222%/783% increase in CD/MD Textest Tear, and 110/189% increase in CD/MD Trap Tear over the dry blended film with no polyethylene (Example Film 4). By comparison, Example Film 5 demonstrated 46% increase in CD Tensile Peak Load, 29% increase in CD Energy to Break, 35%/19% increase in CD/MD Textest Tear, and 9/24% increase in CD/MD Trap Tear over Example Film 4. Further, Example Film 6 demonstrated 45% increase in CD Tensile Peak Load, 28% increase in CD Energy to Break, 17%/139% increase in CD/MD Textest Tear, and 17/20% increase in CD/MD Trap Tear over Example Film 4.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

We claim:

1. A multi-microlayer film having alternating first and second microlayers, the first microlayers comprising an ethylene-based copolymer composition and the second microlayers comprising a propylene-based copolymer composition, wherein each microlayer optionally comprises from about 0 to about 20% by weight polyolefin polymer.

2. The multi-microlayer film of claim 1, wherein the multi-microlayer film has at least four microlayers.

3. The multi-microlayer film of claim 1, wherein the first and second microlayers are sandwiched between two skin layers of composition different from the first and second microlayers.

4. The multi-microlayer film of claim 1, wherein the first and second microlayers each have a maximum thickness of about 6 microns.

5. The multi-microlayer film of claim 1, wherein the first and second microlayers each have a minimum thickness of about 40 nanometers.

6. The multi-microlayer film of claim 1, wherein each first and second microlayer comprises LDPE in a range selected from the group consisting of from about 0.5 to about 20% by weight, from about 5 to about 15% by weight, and from about 8 to about 12% by weight.

7. The multi-microlayer film of claim 1, wherein the ratio of ethylene-based copolymer to propylene-based copolymer is in a range from about 2:1 to about 4:1.

8. A nonwoven composite comprising a nonwoven material and the multi-microlayer film of claim 1 laminated to the nonwoven material.

9. An absorbent article comprising an outer cover, a bodyside liner joined to the outer cover, and an absorbent core positioned between the outer cover and the bodyside liner, wherein the absorbent article includes the nonwoven composite of claim 8.

10. A film comprising from about 25 wt. % to about 46 wt. % by weight ethylene-based copolymer, from about 25 wt. % to about 46 wt. % by weight propylene-based copolymer and from about 0.5% to about 20% by weight polyolefin polymer.

11. The film of claim 10, wherein the ratio of ethylene-based copolymer to propylene-based copolymer is in a range from about 2:1 to about 4:1.

12. A nonwoven composite comprising a nonwoven material and the film of claim 11 laminated to the nonwoven material.

13. An absorbent article comprising an outer cover, a bodyside liner joined to the outer cover, and an absorbent core positioned between the outer cover and the bodyside liner, wherein the absorbent article includes the nonwoven composite of claim 12.

14. The film of claim 1 wherein the polyolefin polymer is selected from the group consisting of polypropylene, polyethylene, and polybutylene.

15. The film of claim 1 wherein the polyolefin polymer is polyethylene, optionally low density polyethylene.
